(19) United States
(12) Patent Application Publication
(10) Pub. No.: US 2008/0162984 A1
(43) Pub. Date: Jul. 3, 2008

(54) Method and apparatus for hardware assisted takeover

(75) Inventors: Pradeep Kalra, San Jose, CA (US); Mitalee Gujar, Santa Clara, CA (US); Sam Cramer, Sunnyvale, CA (US); Susan M. Coatney, Cupertino, CA (US)

Correspondence Address: Jordan M. Becker;BLAKELY, SOKOLOFF, TAYLOR & ZAFMAN LLP, Seventh Floor, 12400 Wilshire Boulevard, Los Angeles, CA, 90025, US

(73) Assignee: Network Appliance, Inc., Sunnyvale, CA (US)

(21) Appl. No.: 11/648,039

(22) Filed: Dec. 28, 2006

(51) Int. Cl. G06F 11/07

(52) U.S. Cl. 714/4

(57) ABSTRACT

The present invention includes a processing system. The processing system includes a controller to manage the processing system. The processing system also includes a remote management module coupled to said controller and a network. The remote management module to monitor operating conditions of said controller and to send a message on said network responsive to operating conditions that indicate a failure of said controller to a failover partner.

### FIELD OF THE INVENTION

At least one embodiment of the present invention pertains to computer networks and more particularly, to a method and apparatus for hardware assisted takeover for a storage-oriented network.

### BACKGROUND

In many types of computer networks, it is desirable to have redundancy in the network to ensure availability of services should a node in the network fail. For example, a business enterprise may operate a large computer network that includes numerous client and server processing systems (hereinafter “clients” and “servers”, respectively). With such a network, the failure of a client or more particularly a server on the network could result in loss of data and loss of productivity that results in costing the business enterprise time and money. To prevent such a scenario, a network having a topology or a mechanism to operate despite the failure of a client or a server in the network is desirable.

One particular application in which it is desirable to have this capability is in a storage-oriented network, i.e., a network that includes one or more storage servers that store and retrieve data on behalf of one or more clients. Such a network may be used, for example, to provide multiple users with access to shared data or to backup mission critical data.

A storage server is coupled locally to a storage subsystem, which includes a set of mass storage devices, and to a set of clients through a network, such as a local area network (LAN) or wide area network (WAN). The mass storage devices in the storage subsystem may be, for example, conventional magnetic disks, optical disks such as CD-ROM or DVD based storage, magneto-optical (MO) storage, or any other type of non-volatile storage devices suitable for storing large quantities of data. The mass storage devices may be organized into one or more volumes of Redundant Array of Inexpensive Disks (RAID). The storage server operates on behalf of the clients to store and manage shared files or other units of data (e.g., blocks) in the set of mass storage devices. Each of the clients may be, for example, a conventional personal computer (PC), workstation, or the like. The storage subsystem is managed by the storage server. The storage server receives and responds to various read and write requests from the clients, directed to data stored in, or to be stored in, the storage subsystem.

One current technique to employ redundancy in a storage-oriented network is to have the storage server coupled with another storage server through a communication link. The storage servers are configured as failover partners. In such a technique each storage server would monitor the operating status of the other using a heartbeat mechanism through the dedicated communication link. The heartbeat mechanism sends a periodic signal to the other storage server to indicate that the storage server is still operational. If a storage server detects that a heartbeat signal has not been received from the other storage server, that storage server will initiate a takeover of the processes (i.e., takeover the responsibilities) of the failed storage server. Filer products made by Network Appliance, Inc. of Sunnyvale, Calif., are an example of storage servers which have this type of capability.

The problem with a heartbeat failure detection scheme is that the mechanism relies on the working storage server, a partner storage server that has not failed, to determine that the other storage server has failed. Furthermore, the mechanism relies on the non-real-time nature of the software or firmware of the storage server. That is, a partner storage server cannot always react immediately to a loss of a heartbeat signal because the partner storage server might be in the middle of completing other tasks. Therefore, the tasks are completed or properly postponed before a partner storage server may recognize that a heartbeat signal from a partner storage server is absent. This non-real-time nature causes the detection of a failure to occur a significant length of time after the actual failure occurs. Setting detection time of a missing heartbeat message to a smaller time interval can result in takeovers occurring even though an actual failure has not occurred. Events that can cause false takeovers include events such as a temporarily unresponsive storage server or a delay caused by software or firmware because of high demand of resources. To ensure such premature takeovers of storage servers are avoided, safeguards are used to ensure that the lack of a heartbeat signal is because of an actual failure of the storage server and not a delay caused by software or hardware. Safeguards to ensure that the lack of a heartbeat signal represents a true failure of a storage server result in the detection time of the failure being increased so that false takeovers are minimized. Therefore, these safeguards undesirably tend to increase the detection time and, ultimately, the amount of time necessary to takeover a failed storage server.

### SUMMARY OF THE INVENTION

The present invention includes a processing system. The processing system includes a controller to manage the processing system. The processing system also includes a remote management module coupled to said controller and a network. The remote management module to monitor operating conditions of said controller and to send a message on said network responsive to operating conditions that indicate a failure of said controller to a failover partner.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates an embodiment of a storage-oriented network having storage server redundancy using a management module;

FIG. 2 illustrates a block diagram of a storage server according to an embodiment;

FIG. 3 illustrates a block diagram showing components of an embodiment of a management module;

FIG. 4 illustrates interface connections of an embodiment of a management module;

FIG. 5 illustrates a block diagram showing communications interface between the agent and a management module and other components, according to embodiments of the invention; and

FIG. 6 illustrates a flow diagram of an embodiment of a process of event detection by a management module.

### DETAILED DESCRIPTION

A method and apparatus for a hardware assisted takeover of a processing system are described. A processing system, such as a storage server, may include a management module, such as a service processor that enables remote management of the processing system via a network. The management module is used to monitor for various events in the processing system. The management module is a service processor that runs independently of the processing system and is optimized to detect events, such as failures, of a processing system. Moreover, the management module reports the events to at least one other storage server, such as a partner processing system, through a communication link. The storage servers are configured as failover partners. In such a technique, each storage server would monitor the operating status of the other through the dedicated communication link.

Furthermore, the network connectivity of the management module and the ability of the management module to monitor various events in the processing system equip the management module with the ability to detect and send a message to a partner processing system, such as a partner storage server, to inform the partner processing system of a failure. Once the partner processing system knows of the failure of the processing system, the partner processing system takes over the processing duties or services of the failed system.

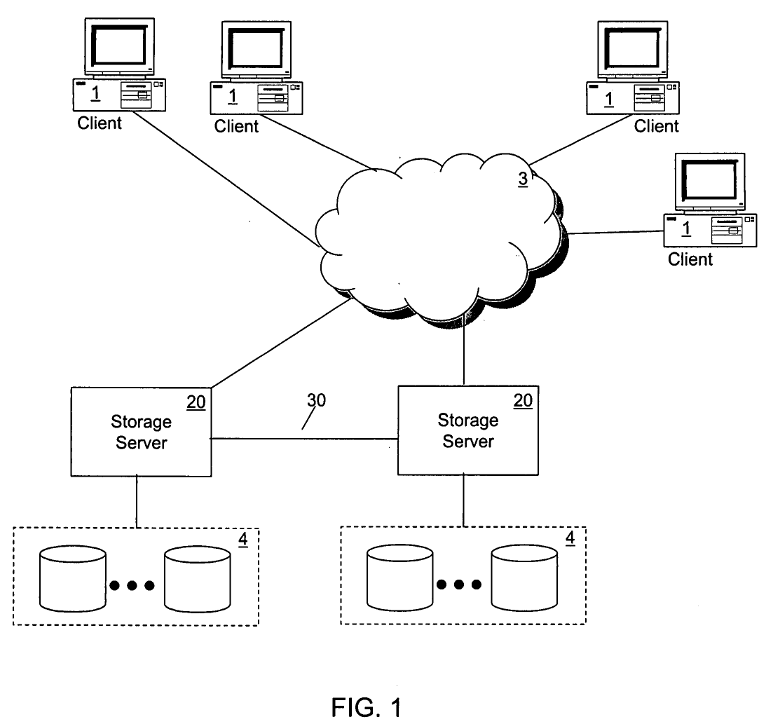

FIG. 1 illustrates an embodiment of a storage-oriented network having storage server redundancy. In FIG. 1, each storage server 20 is coupled to a storage subsystem 4, which includes a set of mass storage devices. Moreover, the storage servers 20 are coupled with clients 1 through a network 3. A network may include a local area network (LAN) or a wide area network (WAN). In an exemplary embodiment, clients 1 are divided into groups that are predominantly served by a particular storage server 20. Thus, each storage server 20 operates on behalf of a set of clients 1 to store and manage shared files or other units of data (e.g., blocks) in a set of mass storage devices 4. Moreover, an exemplary embodiment includes a direct communication link 30 between a storage server 20 and a partner storage server 20. The direct communication link 30 may be used to transfer information between storage servers 20, such as data for processing, secure communications between storage servers 20, and heartbeat signals to monitor the health of a partner storage server 20. In an exemplary embodiment, the direct communication link 30 is an Ethernet link.

In an exemplary embodiment of a storage-oriented network having storage server redundancy, the storage server 20 communicates with a partner storage server 20 through a network 3. The network connection allows a storage server 20 to transmit status information to the partner storage server 20 and visa versa. The information transmitted to the partner storage server 20 may then be used by the partner storage server 20 to initiate a procedure to takeover the processes of a failed storage server 20, such as servicing the set of clients 1 of a failed storage server 20. In an exemplary embodiment, transmission of status information through a network 3 is preformed by a management module. Other terms used for a management module may include a remote management module (RMM), remote LAN module (RLM), remote management card, or service processor.

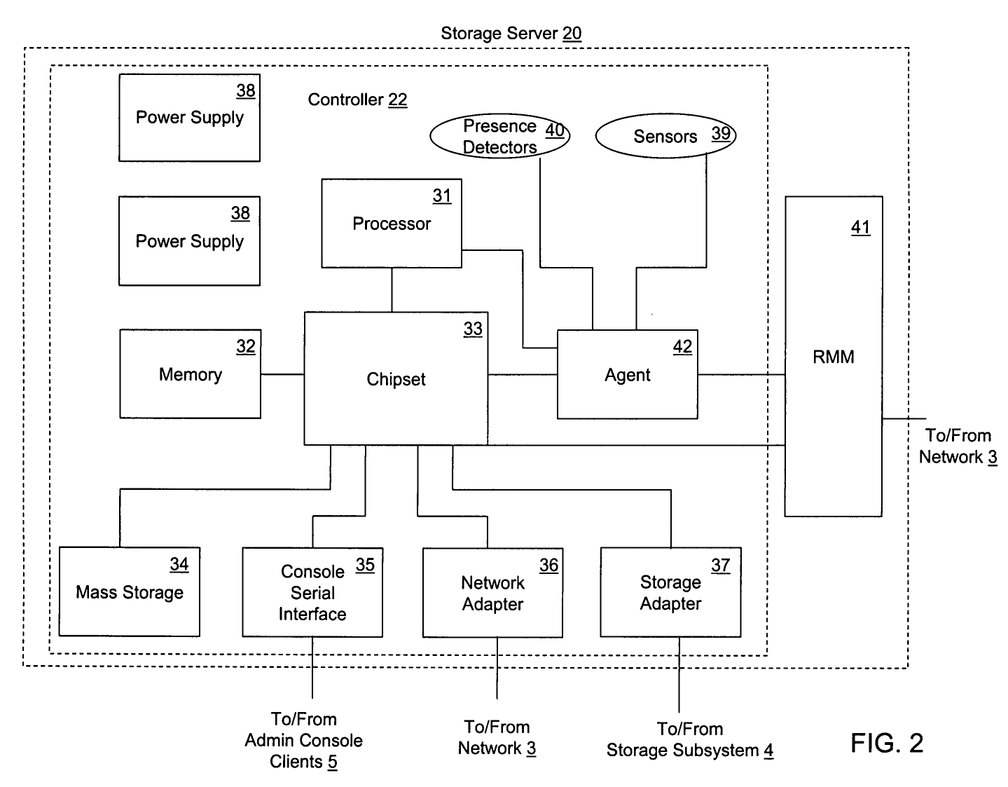

FIG. 2 is a high-level block diagram of a storage server 20, according to at least one embodiment of the invention. Storage server 20 may be, for example, a file server, and more particularly, may be a network attached storage (NAS) appliance (e.g., a filer). Alternatively, the storage server 20 may be a server which provides clients 1 with access to individual data blocks, as may be the case in a storage area network (SAN). Alternatively, the storage server 20 may be a device which provides clients 1 with access to data at both the file level and the block level.

The FIG. 2 exemplary embodiment of a storage server 20 includes a controller 22 and an RMM 41. The controller 22 of a storage server 20 may include one or more processors 31 and memory 32, which are coupled to each other through a chipset 33. The chipset 33 may include, for example, a conventional Northbridge/Southbridge combination. The processor(s) 31 represent(s) the central processing unit (CPU) of the storage server 20 and may be, for example, one or more programmable general-purpose or special-purpose microprocessors or digital signal processors (DSPs), microcontrollers, application specific integrated circuits (ASICs), programmable logic devices (PLDs), or a combination of such devices. The memory 32 may be, or may include, any of various forms of read-only memory (ROM), random access memory (RAM), Flash memory, or the like, or a combination of such devices. The memory 32 stores, among other things, the operating system of the storage server 20. The controller 22 of storage server 20, in an exemplary embodiment, also includes one or more internal mass storage devices 34, a console serial interface 35, a network adapter 36 and a storage adapter 37, which are coupled to the processor(s) through the chipset 33. The controller 22 of a storage server 20 may further include redundant power supplies 38, as shown.

The internal mass storage devices 34 may be or include any conventional medium for storing large volumes of data in a non-volatile manner, such as one or more magnetic or optical based disks. The serial interface 35 allows a direct serial connection with a local administrative console and may be, for example, an RS-232 port. The storage adapter 37 allows the storage server 20 to access the storage subsystem 4 and may be, for example, a Fibre Channel adapter or a SCSI adapter. The network adapter 36 provides the storage server 20 with the ability to communicate with remote devices, such as the clients 1, over network 3 and may be, for example, an Ethernet adapter.

The controller 22 of a storage server 20 further includes a number of sensors 39 and presence detectors 40. The sensors 39 are used to detect changes in the state of various environmental variables in the storage server 20, such as temperatures, voltages, binary states, etc. The presence detectors 40 are used to detect the presence or absence of various components within the storage server 20, such as a cooling fan, a particular circuit card, etc.

In an exemplary embodiment, the RMM provides a network interface and is used to transmit status information of a storage server 20, such as information indicating a failure, to a partner storage server 20. As shown in the FIG. 2 exemplary embodiment, the RMM 41 is coupled with an agent 42 and to a chipset 33 to interface with the software or firmware of the controller 22. The RMM 41 monitors communication with the agent 42 and the software/firmware for events, such as a failure, an abnormal system reboot, a system reset, a system power off, a power on self-test (POST) error, and boot errors. In another embodiment, the RMM 41 monitors for a failure event without the use of an agent 42. Once a failure event is detected by the RMM 41, the RMM 41 notifies a partner storage server 20 of a failure through a network 3. Exemplary embodiments of the present invention are not limited to the use of an RMM 41 to detect and to notify a partner storage server 20 of a failure event, but may use any hardware configuration or hardware combination that provides the ability to detect a failure event and the ability to notify a partner storage server 20 of a failure event. For example, a hardware configuration may include any number of processors, interfaces, and logic to perform the monitoring for a failure and notification of a failure to a partner storage server 20. Examples of hardware combinations may include an agent and remote management module combination, a management controller and remote management module combination, and a single management module to perform the monitoring for a failure and notification of a failure to a partner storage server 20.

In response to receiving a notification of a failure, a partner storage server 20 will takeover servicing the clients 1 of the failed storage server 20. In an exemplary embodiment, a partner storage server 20 does not need an RMM 41 to takeover a failed storage server 20 upon receiving notification of a failure from an RMM 41. Furthermore, a failure detection scheme using an RMM may be supplemented with a heartbeat mechanism that is monitored by software/firmware of a partner storage server 20. In an exemplary embodiment, the heartbeat mechanism operates over a direct communication link 30. In an exemplary embodiment using both a heartbeat mechanism and RMM 41 failure detection, the partner storage server 20 will commence a takeover of a failed storage server 20 upon the absence of receiving a heartbeat signal from the storage server 20 for a specified period of time or upon receiving notification of a failure from an RMM 41 of the failed storage server 20. Commencement of a takeover may occur through a partner storage server 20 emulating the failed storage sever 20 to serve the clients 1 of the failed server 20, as will be discussed below.

Moreover, the RMM 41 in an exemplary embodiment is used to allow a remote processing system, such as an administrative console, to control and/or perform various management functions on the storage server 20 via network 3, which may be a LAN or a WAN, for example. The management functions may include, for example, monitoring various functions and state in the storage server 20, configuring the storage server 20, performing diagnostic functions on and debugging the storage server 20, upgrading software on the storage server 20, etc. In certain exemplary embodiments of the invention, the RMM 41 provides diagnostic capabilities for the storage server 20 by maintaining a log of console messages that remain available even when the storage server 20 is down. The RMM 41 is designed to provide enough information through logs to determine when and why the storage server 20 failed, even by providing log information beyond that provided by the operating system of the storage server 20. In exemplary embodiments, logs include console logs, hardware event logs, software system event logs (SEL), and critical signal monitors.

The functionality of an RMM includes the ability of the RMM 41 to send a notice to a remote administrative console automatically, indicating that the storage server 20 has failed, even when the storage server 20 is unable to do so. For example, an exemplary embodiment of the RMM 41 runs on standby power and/or an independent power supply, so that it is available even when the main power to the storage server 20 is off. The ability to operate independently the operating conditions of the storage server provides the RMM the ability to communicate a failure of a storage server 20 despite loss of power to the storage server 20, inoperability of the hardware of the storage server 20, or the inoperability of software/firmware of the storage server 20. An exemplary embodiment includes an RMM 41 sending notification of a failure using a network connection such as a WAN or a LAN.

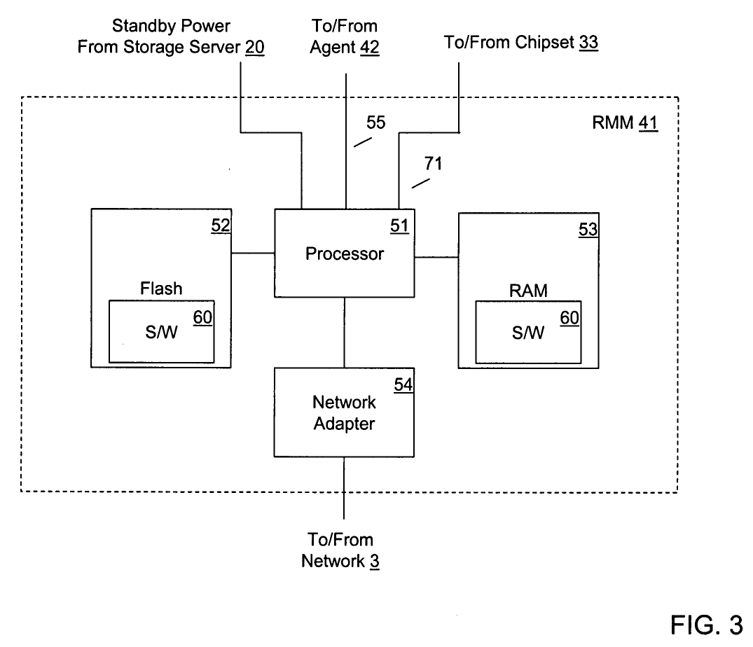

FIG. 3 is a high-level block diagram showing components of the RMM 41, according to certain embodiments of the invention. The various components of the RMM 41 may be implemented on a dedicated circuit card installed within the storage server, for example. Alternatively, the RMM 41 could be dedicated circuitry that is part of the storage server 20 but isolated electrically from the rest of the storage server 20 (except as required to communicate with the agent 42). The RMM 41 includes control circuitry, such as one or more processors 51, as well as various forms of memory coupled to the processor, such as flash memory 52 and RAM 53. The RMM 41 further includes a network adapter 54 to connect the RMM 41 to the network 3. The network adapter 54 may be or may include, for example, an Ethernet (e.g., TCP/IP) adapter. Although not illustrated as such, the RMM 41 may include a chipset or other form of controller/bus structure, connecting some or all its various components.

The processor(s) 51 is/are the CPU of the RMM 41 and may be, for example, one or more programmable general-purpose or special-purpose microprocessors, DSPs, microcontrollers, ASICs, PLDs, or a combination of such devices. The processor 51 inputs and outputs various control signals and data 55 to and from the agent 42. In at least one exemplary embodiment, the processor 51 is a conventional programmable, general-purpose microprocessor which runs software from local memory on the RMM 41 (e.g., flash 52 and/or RAM 53). In an exemplary embodiment, the software of the RMM 41 has two layers, namely, an operating system kernel and an application layer that runs on top of the kernel 61. In certain exemplary embodiments, the kernel 61 is a Linux based kernel.

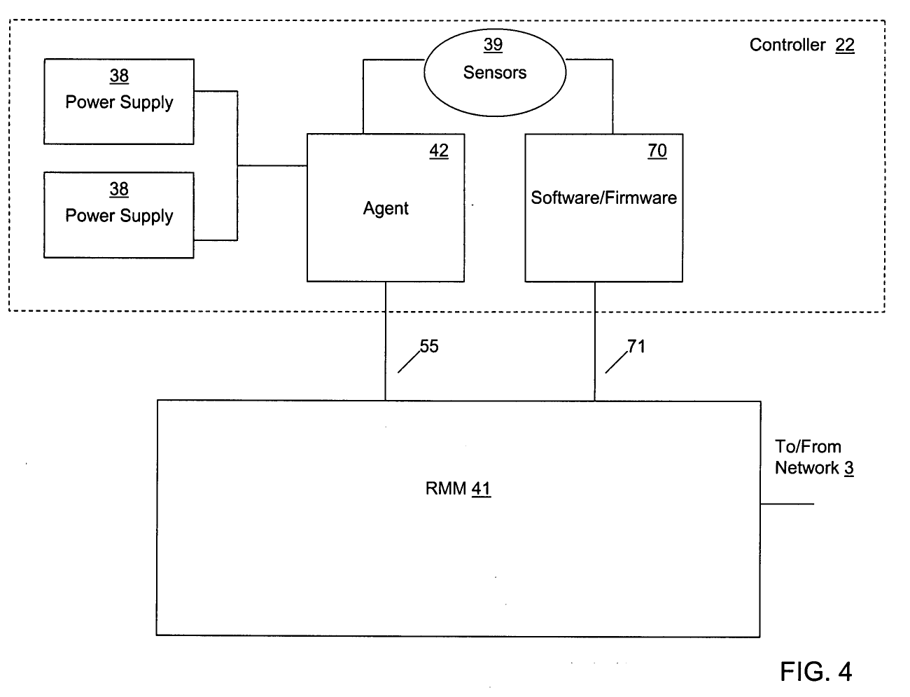

FIG. 4 illustrates at a high level the RMM 41 interfaces between the software/firmware 70 running on the storage server 20 and an agent 42 of a storage server 20 that allow the RMM 41 to monitor the status of the storage server 20, according to certain exemplary embodiments. In an exemplary embodiment, a serial bus interface 71 between the software/firmware and a RMM 41 may be an inter-IC (IIC or I2C) bus. In other exemplary embodiments the interface provided by IIC bus may be replaced by an SPI, JTAG, USB, IEEE-488, RS-232, LPC, IIC, SMBus, X-Bus or MII interface. The software/firmware 70 may send configuration information, administration information, and events to the RMM through a serial bus interface 71.

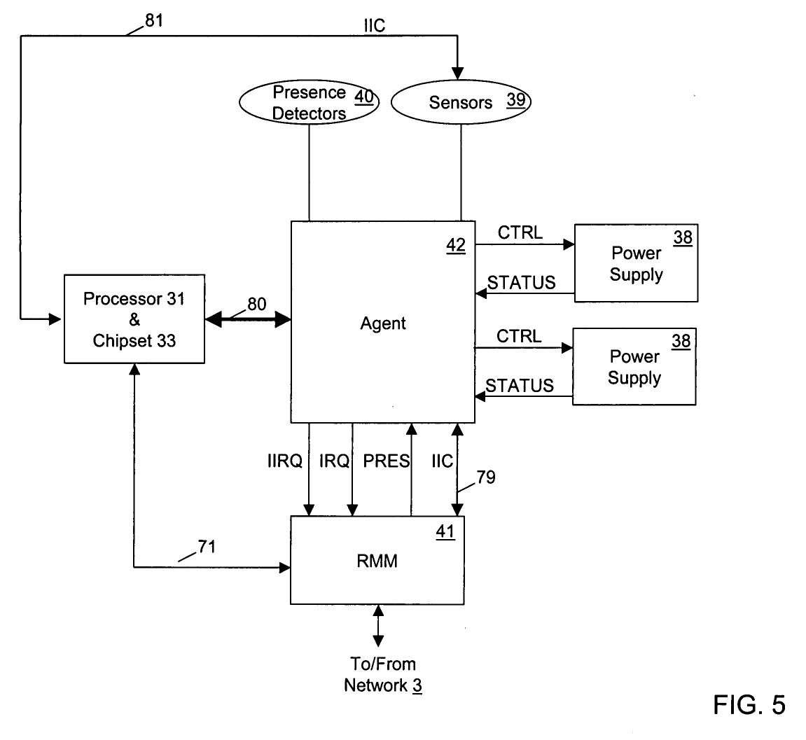

The agent 42 and the RMM 41 are also connected by a bidirectional inter-IC (IIC or I2C) bus 79, as shown in FIG. 5, which is primarily used for communicating data on monitored signals and states (i.e. event data) from the agent 42 to the RMM 41. Note that in other exemplary embodiments of the invention, an interconnect other than IIC can be substituted for the IIC bus 79. For example, in other exemplary embodiments the interface provided by IIC bus 79 may be replaced by an SPI, JTAG, USB, IEEE-488, RS-232, LPC, IIC, SMBus, X-Bus or MII interface. The agent 42, at a high level, monitors various functions and states within the storage server 20 and acts as an intermediary between the RMM 41 and the other components of the storage server 20, in certain exemplary embodiments. Hence, the agent 42 is coupled to the RMM 41 as well as to the chipset 33 and the processor(s) 31 of the storage server 20, and receives input from the sensors 39 and presence detectors 40. The interface 80 between the agent 42 and the CPU 31 and chipset 33 of the storage server 20 is similar to that between the agent 42 and the RMM 41. The agent 42, in an exemplary embodiment, is embodied as one or more integrated circuit (IC) chips, such as a microcontroller, a microcontroller in combination with an FPGA, or other configuration. The sensors 39 further are connected to the CPU 31 and chipset 33 by an IIC bus 81. The agent 42 further provides a control signal (CTRL) to each power supply 38 to enable/disable the power supplies 38 and receives a status signal STATUS from each power supply 38.

An exemplary embodiment includes the software/firmware 70 transferring configuration information to be stored in the RMM and used to transmit failure messages to a partner storage server 20. In an exemplary embodiment, the configuration information transferred by the software/firmware 70 to the RMM includes the IP address of a failover partner storage server 20, port number of the port at which the partner storage server 20 is to receive failure messages, such as a user datagram protocol (UDP) port number or a transmission control protocol (TCP) port number, time interval to send a heartbeat message to a partner storage server 20 to verify that the management module is operational, and an authentication key. In an exemplary embodiment using an authentication key, the authentication key is shared with the partner storage server 20 through a secure communication link, such as a direct communication link 30 connecting a storage server 20 to a partner storage server 20. In certain exemplary embodiments the authentication key is a shared secret that is generated and shared between the storage servers 20. The use of an authentication key ensures that a failure message received through the network 3 from a storage server 20 is genuine. In an exemplary embodiment, once an authentication key is used to send a failure message to a partner storage server 20, a new authentication key is generated by the software or firmware and stored in the RMM 41 and sent to the partner storage server 20 over the direct communication link 30. In an exemplary embodiment, an authentication key may be generated using dedicated hardware. In an exemplary embodiment, an authentication key is generated using the output of a random number generator as the authentication key.

The software/firmware 70 also updates configuration data stored in an RMM 41 if any of the configuration data is changed. This ensures upon an occurrence of a failure event that the RMM 41 will send the failure notification so that a partner storage server 20 will respond to the failure. Furthermore, exemplary embodiments of a storage server 20 include an RMM 41 that may send a test message to a partner storage server 20 to verify that the RMM 41 is properly configured to communicate with the partner storage server 20. One such exemplary embodiment includes a test message or keep alive message sent from a controller 22 to a RMM 41, which then sends a message across a user datagram protocol (UDP) network to a partner storage server 20. Upon receipt of the test message or keep alive message, the partner storage server 20 acknowledges the message, which validates the configuration is working properly.

In an exemplary embodiment, the agent 42 monitors for any of various events that may occur within the processing system. In an exemplary embodiment various events may include such as a failure, an abnormal system reboot, a system reset, a system power off, a power on self-test (POST) error, and boot errors. The processing system includes sensors to detect at least some of these events. In an exemplary embodiment, the agent 42 includes a first-in first-out (FIFO) buffer. Each time an event is detected, the agent 42 queues an event record describing the event into the FIFO buffer. When an event record is stored in the FIFO buffer, the agent 42 asserts an interrupt to the RMM 41. The interrupt remains asserted while event record data is present in the FIFO.

When the RMM 41 detects assertion of the interrupt, the RMM 41 sends a request for the event record data to the agent 42 over a dedicated link between the agent 42 and the RMM 41. In response to the request, the agent 42 begins dequeuing or removing the event record data from the FIFO and transmits the data to the RMM 41. The RMM 41 timestamps the event record data as they are dequeued and stores the event record data in a non-volatile event database in the RMM 41. The RMM 41 may then transmit the event record data to a remote administrative console over the network, where the data can be used to output an event notification to the network administrator. Furthermore, the RMM 41 may generate a message to send to a partner storage server 20 if the event indicates a failure of the storage server 20. For example, the RMM 41 may generate a message that indicates operating conditions indicate a failure of the storage server 20 by formatting a message to be sent over a network connection between the failed storage server 20 and a partner storage server 20. An event that may trigger the RMM 41 to generate a failure message includes loss of power of the storage server 20, loss of power of a vital component of the storage server 20, system reset because of a watchdog timeout, power on self-test (POST) errors during the boot process, abnormal system reboots, environmental problems, hardware failure, or loss of communication with software/firmware 70. For an embodiment, events are encoded with event numbers by the agent 42, and the RMM 41 has knowledge of the encoding scheme. As a result, the RMM 41 can determine the cause of any event (from the event number) without requiring any detailed knowledge of the hardware.

As shown in FIG. 5, an exemplary embodiment of a storage server 20 includes an agent 42 connected to RMM 41. RMM 41 receives from the agent 42 two interrupt signals, such as a normal interrupt IRQ and an immediate interrupt IIRQ. The normal interrupt IRQ is asserted whenever the FIFO buffer (not shown in FIG. 5) in the agent 42 contains event data, and the RMM 41 responds to the normal interrupt IRQ by requesting data from the FIFO buffer. In contrast, the immediate interrupt IIRQ is asserted for a critical condition which must be acted upon immediately, such as an imminent loss of power to the storage server 20. The agent 42 is preconfigured to generate the immediate interrupt IIRQ only in response to a specified critical event, and the RMM 41 is preconfigured to know the meaning of the immediate interrupt IIRQ (i.e., the event which caused the immediate interrupt IIRQ). Accordingly, the RMM 41 will respond to the immediate interrupt IIRQ with a preprogrammed response routine, without having to request event data from the agent 42. The preprogrammed response to the immediate interrupt IIRQ may include, for example, automatically dispatching an alert e-mail or other form of electronic alert message to the remote administrative console. Although only one immediate interrupt IIRQ is shown and described here, the agent 42 can be configured to provide multiple immediate interrupt signals to the RMM 41, each corresponding to a different type of critical event.

In an exemplary embodiment, the RMM 41 uses a command packet protocol to communicate with an agent 42. This protocol, in combination with the FIFO buffer and described above, provides a universal interface such that between the RMM 41 and the agent 42. The universal interface of the RMM 41 allows the RMM 41 to be used across different platforms of storage servers 20 because a communication protocol between an RMM 41 and an agent 42 is defined and is not dependent on any particular management module, such as an RMM 41.

The command packet protocol may include a slave address field, read/write bit, data bits, a command field, parameter field. In exemplary embodiments the slave address field includes seven bits representing the combination of a preamble (four bits) and slave device ID (three bits). The device ID bits are typically programmable on the slave device (e.g., via pin strapping). Hence, multiple devices can operate on the same bus. The read/write bit designates whether a read or write operation to an address is to be performed (e.g., “1” for reads, “0” for writes). The data field represents data sent to and from an RMM 41 and an agent 42. In exemplary embodiments, an 8-bit value represents data. The command field, for an exemplary embodiment, is a 16-bit value. Examples of such commands are commands used to turn the power supplies 38 on or off, to reboot the storage server 20, to read specific registers in the agent 42, and to enable or disable sensors and/or presence detectors. The parameter field is an optional field used with certain commands to pass parameter values.

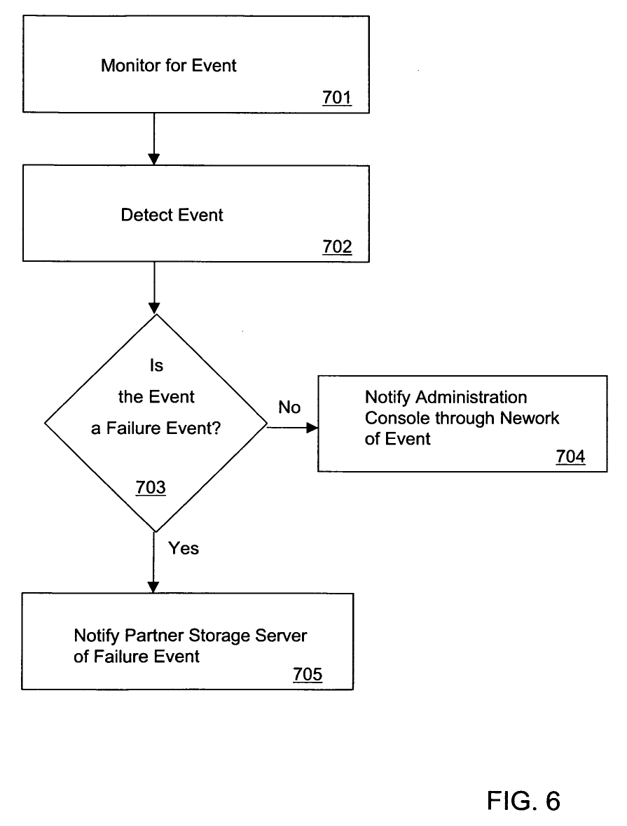

FIG. 6 illustrates a flow diagram of an event detection scheme of a storage server 20 using an RMM 41 according to one exemplary embodiment of the invention. At block 701 the RMM 41 monitors for failure events occurring within a storage server 20. In an exemplary embodiment, the RMM 41 monitors for failure events by receiving input from an agent 42 that relays information received from sensors 39 within the storage server 20. Moreover, the RMM 41, in an exemplary embodiment, receives operating conditions from software/firmware 70 of the storage server 20. Once detection of an event by the RMM 41 as illustrated by block 702 occurs, the RMM 41 analyzes the event at block 703 to determine if the event is a failure event. In an exemplary embodiment, a failure event can include loss of power of the storage server 20 or a vital component of the storage server 20, system reset because of a watchdog timeout, power on self-test (POST) errors during the boot process, abnormal system reboots, environmental problems, hardware failure, or loss of communication with software/firmware 70. If the event is determined not to be a failure event the RMM 41 notifies an administration console of the event, as illustrated in block 704, and/or logs the event in a log. For an exemplary embodiment, RMM 41 notifies an administration console of the event by sending a message through a network 3. If the event is determined by the RMM 41 to be a failure event, as illustrated in block 705, the RMM 41 notifies a partner storage server 20 of the failure through the network 3. The detection time of a failure by an RMM 41 and notifying a partner storage server 20 of the failure occurs in less than fifteen seconds for a certain exemplary embodiment. Another exemplary embodiment includes a configuration where the partner storage server 20 is notified of a failure of a storage server by an RMM 41 in less than five seconds after the failure occurred. Such a notification may be transmitted to the partner storage server 20 using any kind of user datagram protocol (UDP) packet or even a connection based transmission control protocol (TCP) session. For an embodiment, the RMM 41 notifies the partner storage server 20 of a failure using a simple network management protocol (SNMP) formatted message sent over the network 3 to a user datagram protocol (UDP) port on the partner storage server 20.

As discussed above, the partner storage server 20, upon receiving notification of a failure event from a storage server 20, takes over operations of the failed storage server 20 by serving the clients 1 of the failed storage server. In an exemplary embodiment, serving a client 1 may include storing and managing shared files or other units of data (e.g., blocks) in the set of mass storage devices 4. In an exemplary embodiment, the partner storage server 20 takes over the operations of a failed server by emulating the address of the failed storage server 20. In such an exemplary embodiment, the address of the failed storage server 20 is transmitted to the partner storage server 20 through the direct communication link 30 prior to a failure, such as during a boot up routine of a storage server 20. In an exemplary embodiment the address may be an Internet protocol (IP) address or a medium access control (MAC) address. Furthermore, the address may be stored in the partner storage server 20 for possible later use. This address is then used by the partner storage server 20, in addition to the address used to serve clients 1 of the partner storage server 20, so the clients 1 of the failed storage server 20 interact with the partner storage server 20 instead of attempting to interact with the failed storage server 20. The partner storage server 20 continues to operate on behalf of the clients 1 of the failed storage server 20 until the failed storage server 20 is again operational. Once the partner storage server 20 is notified that the previously failed storage server 20 is now operational, the partner storage server 20 may transition the servicing of the clients 1 of the once failed storage server 20 back to that storage server 20 (i.e., “give-back”).

Thus, a method and apparatus for hardware assisted takeover for a storage-oriented network have been described. Although the present invention has been described with reference to specific exemplary embodiments, it will be recognized that the invention is not limited to the exemplary embodiments described, but can be practiced with modification and alteration within the spirit and scope of the appended claims. For example, exemplary embodiments of the invention are not limited to using an RMM 41 and an agent 42 configuration. Exemplary embodiments of the present invention include any hardware component and hardware configuration in a storage server 20 that has the ability to detect a failure of that storage server 20 and the ability to transmit a notification of the failure to a partner storage server 20. Accordingly, the specification and drawings are to be regarded in an illustrative sense rather than a restrictive sense.

What is claimed is:

1. A processing system comprising:
a controller to manage the processing system; and
a management module coupled to said controller and a network to monitor operating conditions of said controller and the management module configured to send a message on said network responsive to operating conditions that indicate a failure of said controller to a failover partner.

2. The processing system of claim 1, wherein said message includes an authentication key used by said failover partner to verify that the message originated from said controller.

3. The processing system of claim 1, wherein said message is a simple network management protocol (SNMP) formatted message.

4. The processing system of claim 2, wherein said authentication key is transmitted to said failover partner from said controller prior to said failure of said controller through a secure communication link between said controller and said failover partner.

5. The processing system of claim 4, wherein said authentication key is a shared secret that is used only once.

6. The processing system of claim 4, wherein said failover partner takes over services provided by said controller responsive to said message.

7. The processing system of claim 2, wherein said management module operates independently of said operating conditions of said controller.

8. The processing system of claim 2, wherein said management module sends said message on said network responsive to operating conditions selected from a group consisting of loss of power of said controller, loss of power of a vital component of said controller, system reset because of a watchdog timeout, power on self-test errors during the boot process, abnormal system reboots, environmental problems, hardware failure, and loss of communication with software on said controller.

9. A storage system comprising:
a first server coupled with a first mass storage device and a network to service a first set of clients;
a second server coupled with a second mass storage device and said network to service a second set of clients; and
a management module coupled with said first server and said network, wherein said management module notifies said second server of a failure of said first server through said network.

10. The storage system of claim 9, wherein said second server services said first set of clients upon notification of a failure of said first server.

11. The storage system of claim 10, wherein said services include the storage and management of shared files or other units of data.

12. The storage system of claim 9, wherein said management module receives information from an agent coupled with a sensor that indicates a failure.

13. The storage system of claim 12, wherein said management module receives information from software loaded on said first server that indicates a failure.

14. The storage system of claim 13, wherein said management module notifies said second server through said network by sending a simple network management protocol message upon detection of an event selected from a group consisting of loss of power of said controller, loss of power of a vital component of said controller, system reset because of a watchdog timeout, power on self-test errors during the boot process, abnormal system reboots, environmental problems, hardware failure, and loss of communication with software on said controller.

15. The storage system of claim 13, wherein said management module further includes a central processor unit and a power source independent of said first storage server that allows said management module to operate despite said failure of said first storage server.

16. The storage system of claim 14, wherein said simple network management protocol message includes an authentication key used by second server to ensure the message originated from said first server.

17. A method comprising:
monitoring for a failure event in a first controller of a storage system coupled with a network through a remote management module;
detecting said failure event with said remote management module; and
using said remote management module to transmit a message through said network to a second controller of a storage system responsive to detecting said failure event.

18. The method of claim 17, wherein said message is a packet.

19. The method of claim 18, wherein said packet is a simple network management protocol formatted packet.

20. The method of claim 17, further comprising:
servicing a client of said first controller of a storage system by said second controller of a storage system upon receipt of a packet transmitted responsive to detecting said failure event.

21. The method of claim 20, further comprising:
returning the servicing of said client to said first controller upon notification to said second server that said failure event in said first controller is remedied.

22. The method of claim 17, further comprising:
generating an authentication key in said first controller; and
transmitting said authentication key to said second controller through a secure communication link between said first controller and said second controller.

23. The method of claim 22, wherein said packet includes said authentication key used by said second controller to verify said packet originated from said first controller.

24. The method of claim 23, wherein said authentication key is a shared secret that is regenerated after said shared secret is used to verify said packet originated from said first controller.

25. The method of claim 24, wherein said authentication key is regenerated using a random number generator.

26. The method of claim 17, further comprising:
sending a heartbeat message from said remote management module to said second controller of a storage system to confirm operation of said remote management module.
